(19) United States
(12) Patent Application Publication
(10) Pub. No.: US 2012/0197949 A1
(43) Pub. Date: Aug. 2, 2012

(54) METHOD TO REGISTER VISITORS TO AN EVENT

(76) Inventors: Tamila N. Taylor, Creve Coeur, MO (US); Kelvin J. Taylor, Creve Coeur, MO (US)

(21) Appl. No.: 13/360,200

(22) Filed: Jan. 27, 2012

Related U.S. Application Data
(60) Provisional application No. 61/436,697, filed on Jan. 27, 2011.

(51) Int. Cl. G06F 17/30; G06F 7/00

(52) U.S. Cl. 707/808; 707/802; 707/805; 707/E17.005; 707/E17.008

(57) ABSTRACT

A method to register visitors applies to many events, such as funerals. The method, deployed upon a computer, allows a user to select personalized services. The method also stores event organizer information common to various events. The method then automates the generation of invitations and tracking of RSVPs for an event. Then the method guides event visitors to enter information and comments through a computer into a database. The visitors do so upon a dedicated screen. Following an event, the method provides for production of a book compiling the information and comments of the visitors in a pleasing format suitable for long term use. The method also produces customized printed materials for mailing or emailing to event visitors.

### CROSS-REFERENCE TO RELATED APPLICATION

This non-provisional application claims priority to the pending provisional application 61/436,697 filed on Jan. 27, 2011 which is owned by the same inventors.

### BACKGROUND OF THE INVENTION

The method to register visitors to an event relates to management information systems generally and more specifically to collecting contact information later applied to a mailing program. A unique aspect of the present invention is secure compilation of visitor information and comments into a printed book. The visitors include people attending a wake, a visitation, or a funeral, a rehearsal dinner, a wedding, or a reception, a baptism, similar moments of transition for members of a family, and attendees at trade shows and conventions of all kinds.

Presently, people learn of a person passing and the related funeral arrangements through telephone and email communications and published notices. People learn of wedding related activities often through an invitation but also through preceding save-the-date cards, and telephone and email communications. Relatives and select guests learn of baptisms often by telephone and now email communications. Attendees of conventions learn of the function by an invitation, telephone or email communication, or advertisement in a trade publication. Convention attendees usually complete a registration form prior to attending. Some attendees though do register at the door of a convention. People attending a funeral related event, a wedding, a baptism, or a convention often have comments about the event and the people involved. Collecting those comments can pose a challenge for organizers of the event.

Often, the organizers of funeral related events include the relatives of a decedent. The relatives spend their time, efforts, and emotions receiving visitors and completing the ceremonies. Usually visitors to a funeral related event leave their comments in a book at the door to an event. The organizers review the book following the conclusion of the funeral. Then organizers of a wedding, predominantly brides and their mothers, spend much time and effort into arranging the wedding and related activities for relatives and guests. When the wedding day arrives, brides and their mothers participate in the ceremonies. Usually visitors to a wedding related event leave their comments in a book at the door to the church or the reception. At some weddings, guests sign a plate or other ceramic later fired into final form. The organizers of a wedding review the book or the plate well after the celebration from the wedding has ended. Somewhat like weddings, the organizers of baptisms generally participate in the ceremonies. This participation leaves the organizers little time and effort to collect comments from relatives and guests at the baptism and any follow on lunch. Unlike a family social function, a convention has people register in advance and at the door. With a convention in progress, the organizers once more lack the time and effort to collect comments from pre-registered attendees and on-site registered attendees. Organizers often collect comments from convention attendees through comment cards mailed in later by the attendees. Such cards have a small return rate. Some conventions collect attendee comments through email, website screens, and more recently social media postings, such as Facebook®. Comments though after the convention slip from the attention of attendees and have a reduced response rate compared to comments provided before an attendee departs a convention.

The present invention overcomes the limitations of the prior art. That is, the art of the present invention, a method to register visitors, collects visitor information at an event before a visitor departs. The present invention also prepares the visitor information and comments for use in a book, mailing, or other printed communication by the event organizers following conclusion of the event.

The method to register visitors proactively collects visitor information and comments at an event and then utilizes that information for printed and other communications to the visitors following the event. The difficulty in providing a method to register visitors is shown by a typical funeral. On short notice, relatives and close friends make the arrangements for a funeral shortly after the passing of the decedent. Then the visitation occurs where the relatives receive consolation from other relatives, friends, and in some cases the public. During the visitation, visitors sign a book at a doorway to the visitation room. However, some visitors see others that they would like to meet and skip signing the book. A portion of those visitors return and do sign the book but a sizeable portion of visitors may never sign the book. The relatives have brief, if not little, opportunity to check on the book from time to time. Following the visitation, the relatives then assemble at a religious institution for the last service with the decedent. Some times, the funeral director brings the book to the funeral service for visitors to sign. After the last service, then the relatives proceed to a cemetery or other final destination for the decedent. Usually, the book does not proceed to the cemetery. A funeral director may copy pages of the book for internal use with discretion. Following the interment or other final service, the funeral director presents the book signed by the visitors to the relatives of the decedent. The relatives then do what they wish with the book. Often the book of visitors undergoes perusal by the relatives before going into a box of the decedent's things. Some relatives of a decedent rarely do more with the book and its information. Other relatives of a decedent utilize the information in the book to manually assemble written acknowledgments to the visitors. Though this description refers to a funeral, the description may also apply to weddings, other social events, baptisms, other religious events, and to some extent tradeshows.

### DESCRIPTION OF THE PRIOR ART

Visitors signing a book at a visitation, a reception, a baptismal lunch, and at tradeshow registration have taken place for many years. Few organizers of such events have taken advantage of the information collected. The collected information provides addresses of people connected to the event that has use for future communications to them.

In recent years, others have sought to capitalize on information collected from visitors to an event. The U.S. Pat. No. 7,734,626 to Jaehnig describes a computerized registration system for multiple uses. This system provides a podium upon which rests a computer and a nearby camera. The computer includes software that allows an attendee to enter personal data using a mouse, keyboard, and tablet with pen. The camera concurrently records a picture of the attendee and merges it with the personal data. This system includes follow up software that rectifies attendee data with ZIP code and other databases. Though the system assembles a data file for local or remote computer access, the system briefly mentions follow on communication. The system does not describe generation of follow on communications as an integral component and also does not mention mining of the data file for marketing regarding future events.

Thus, the prior art system and method does not provide for assembly of visitor data at a moment of family transition and subsequent printed communication to the visitors. The present invention allows visitors to provide personal data in electronic form, allows relatives to assemble follow on communications to the visitors using the data, and allows event organizers such as funeral directors, wedding planners, and tradeshow committees to communicate with potential future clients.

### SUMMARY OF THE INVENTION

The method to register visitors applies to a variety of events as when a person departs a family, joins a family, participates in a religious ceremony, or when a person attends a tradeshow or other convention. Before an event, the present invention automates the generation of invitations and tracking of RSVPs. Then after the event starts, the present invention guides visitors, or guests, at an event to enter information through a computer into a database. The database resides upon a central server separate from the event location, often a web based or cloud located database. Following an event, the present invention provides for production of a book compiling the guests' information in a pleasing to read format suitable for long term use. Throughout this specification, the Applicants intend that the terms guests and visitors be interchangeable.

In particular, the present invention collects data from guests, visitors, and attendees of funerals, weddings, and other large gatherings of people. The present invention allows an organizer to manage guest lists and later to create several offerings to improve the efficiency of event organization and retaining the ambiance of the event for later reflection. The present invention deploys upon a laptop type computer positioned at an entrance to an event, such as a doorway to a chapel, an entrance to a reception hall, or a gate to a convention. The laptop computer accesses a database upon a remote server away from the event. The database then accepts and stores visitor information upon entry. The present invention provides a photo of the decedent, the happy couple, and the newly baptized, or the logo of a convention organizing committee. Near the photo, the present invention provides a guest registry screen that prompts guests to enter their names, addresses, and a tribute to the decedent, a well wish to the family, and a positive message to the happy couple, or a comment about the tradeshow. The present invention through the registry screen creates a database of names and demographic information that leads to various product offerings customized to those guests who attended an event.

The present invention through its database supports making these products: a funeral memory book, a wedding and reception memory book, and a baptismal book, or an advanced tradeshow program, data for insertion into fields of customized thank you notes or other printed materials, data for spray on addressing of envelopes, mailing labels, and data for mass email campaigns, among other things.

Besides funerals and visitations, the present invention aids a wedding planner whether a professional or a mother of the bride. The present invention through its database tracks information regarding guests at various stages. The wedding planner inputs the names, mailing addresses, and email addresses of invitees before an event. This allows the present invention to generate mailing labels for invitations and to track the RSVPs as they return. The database may also create multiple invitations and address label sets to other events related to the wedding such as a bridal shower, bachelor party, bachelorette party, rehearsal dinner, golf outing, bridal tea, and the like.

At the location of the big event, the wedding planner or her agents arrange a laptop computer at a suitable location. The computer includes the present invention with the current list of RSVP received and logged into a database. Unlike the old prior art of a guest manually signing a book, each guest enters their mailing and email addresses electronically into the database upon a computer such as a laptop or other digital recording device. The present invention checks the guest's name against the database records. For example, when a guest begins typing her name, the present invention finds her RSVP and automatically populates the guest's demographic information for review. The guest may edit the demographic information if needed. The guest then clicks the enter button to identify her as an official attendee of the event. A guest who has not RSVP'd has a screen presented to her for entering the demographic information. While reviewing demographic information, the present invention provides a guest an opportunity to leave a well wish or positive statement to the happy couple. The present invention collects the attendee names, their associated demographic data, and the well wishes into a database. The database of the invention, upon direction of the event planner, provides data for various products such as mailing lists, memory books, merged documents, customized thank you notes or other printed materials, data for spray on addressing of envelopes, mailing labels, and data for mass email campaigns, among other things. The memory book has a hard cover and includes pages for event information, inspirational poems, passages, and quotations, an attendee list, pictures from the event, and other related items.

Beyond a database and follow on communications, the present invention also provides data to event organizers and hosts for marketing. The hosts include funeral homes, wedding venues, and reception sites where the hosts and organizers utilize the data for marketing and mailing initiatives directed to people who have attended previous events at that venue. The present invention allows for saving its database to aid in planning future events and developing new services. Attendees at an event or organizers after an event may upload pictures into a memory book, increasing the sentimental value of the book. The present invention allows for tracking of an event from its initial conception and planning through its happening then completion along with follow on acknowledgements and thank you notes.

One object of the present invention is to provide a method to register visitors that collects event visitor information into a database for later use in follow on communications to the visitors.

Another object is to provide such a method to register visitors that utilizes prompts and screens to collect information from visitors without embarrassment.

Another object is to provide such a method to register visitors that has a low cost of manufacturing so the purchasing event planners, wedding planners, funeral directors, funeral homes, reception sites, and other organizations can readily buy the method to register visitors through normal supply sources and procurement channels.

Another object is to provide such a method to register visitors that has a low cost of deployment so that the families can readily afford the resulting memory books and follow on communications.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### DESCRIPTION OF THE DRAWINGS

In referring to the drawings,

FIG. 1 shows a block diagram of components of the preferred embodiment of the method to register guests in accordance with the present invention and FIG. 1A continues this block diagram at the A within a circle;

FIG. 2 illustrates a screen where a user can operate the features of the invention;

FIG. 2a shows a screen where a user can view events per day;

FIG. 2b shows a screen where a user can view events by name;

FIG. 3 illustrates a screen where a user can enter information regarding an event venue;

FIG. 4 provides a screen where a user selects components of a book;

FIG. 4a shows a screen where a user can define a template for a later book or note;

FIG. 5 provides a screen where a user establishes an event with the present invention;

FIG. 5a shows a screen where a user can view the sub-events of an event listed chronologically and add additional sub-events;

FIG. 5b shows a screen where a user can view guests invited to an event or sub-event;

FIG. 6 describes a screen where a guest enters information and comments for collection by the invention;

FIG. 7 describes a screen where a user selects finer components of a book produced by the invention;

FIG. 8 shows a screen where a user collects photographs for including into a book;

FIG. 9 shows a screen where a user collects additional text for including into a book;

FIG. 9a illustrates a book produced by the invention;

FIG. 10 depicts a screen where a user selects information and format for production of an acknowledgement note;

FIG. 10a shows a screen of another embodiment where a user prepares an acknowledgement; and,

FIG. 10b illustrates an acknowledgement produced by the invention.

The same reference numerals refer to the same parts throughout the various figures.

### DETAILED DESCRIPTION

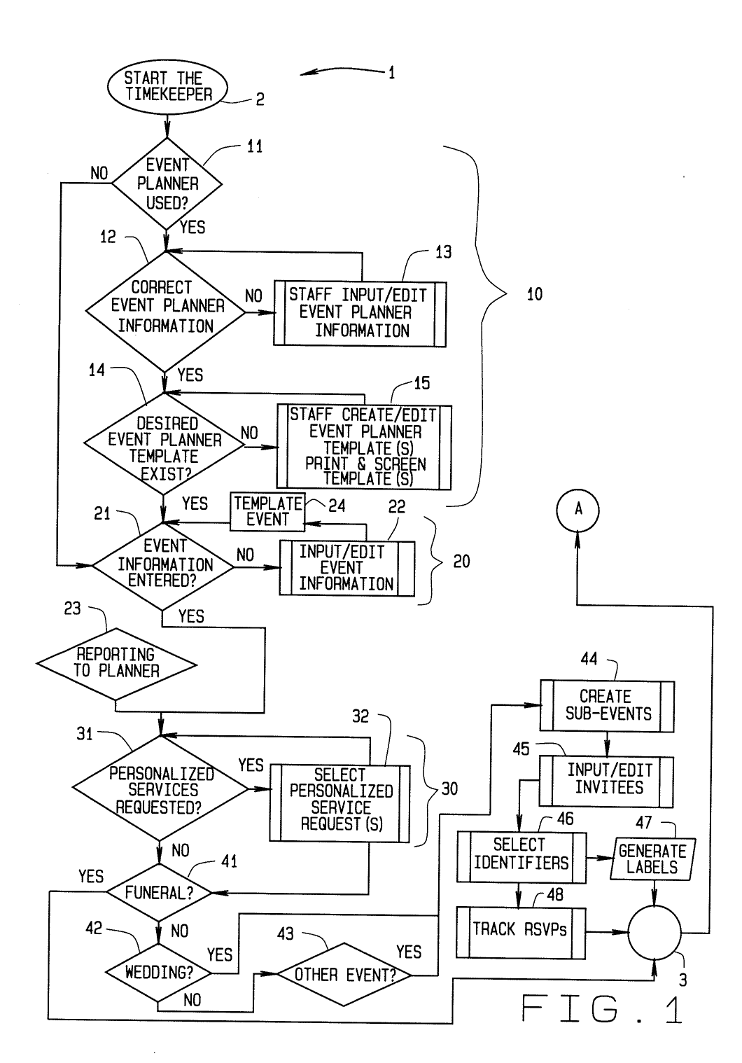

The present art overcomes the prior art limitations by automatically collecting personal information and comments from guests and arranging that information and comments into mailing labels, book form, and acknowledgement note form. Though this description refers to a funeral, the description may also apply to weddings, other social events, baptisms, other religious events, and to some extent tradeshows. Turning to FIG. 1, the method to register visitors to an event utilizes software primarily located in a secure website. Alternatively, the invention's software operates in a stand alone mode upon a computer, particularly a desktop computer. In an alternate embodiment, the present invention operates upon a mobile electronic device, such as a smart phone. In a further alternate embodiment, the present invention operates upon Internet based client-server architecture, including cloud based software. The present invention includes configurations to receive information as a data file from another program, such as Microsoft Excel®, Microsoft Access®, or other database. The present invention 1 begins with its initiation, as at 2, upon a computer such as a laptop computer, desktop computer, other electronic device, upon scanning of a QR, quick response code, by a Smartphone, or upon logging into a client-server program such as through cloud based software. The invention then proceeds into an event planner phase 10 followed by an event phase 20. With an event established, the invention provides for personalized services as at 30 that include pre-event management as at 40. Following selection of an event and related services if any, the present invention shifts to operating an event as at 3. Upon an event beginning, the present invention provides a guest registry 4 at the event site which then collects guest information through a registry as at 50. Guests may also leave comments and information utilizing a virtual guest book upon the Internet generally supported by an event planner, such as a funeral home. After the event, a user directs the present invention for preparing the guest information as at 60. The prepared guest information then feeds into the printing of follow on communications as at 70. With tasks of the invention complete, a user ends the present invention as at 5.

Turning to the planner phase 10, the present invention queries a user about whether the user qualifies as an event planner at 11. If the user replies as she is not an event planner, the present invention moves to the event phase 20. For an event planner, the present invention provides any previously stored name, company, and address information for the event planner as at 12. For an event planner new to the present invention, the invention provides a screen prompting the event planner to enter select information as at 13. The select information includes name of the planner, company or venue such as a funeral home, mailing address, telephone numbers—such as mobile phone, cell, fax, landline—email address, website address, social media information such as Facebook® name or Twitter® handle, and the like. The company or venue will host most of the event and sub-events. A planner, such as a funeral director, may access the present invention over the Internet through a secure website using a password and username, including remote access where the invention operates upon a server located well away from an event location. The planner may access the invention when stored and operated through cloud computing. The planner establishes a password and username upon initial login to the invention over the Internet using a temporary password provided by an approved vendor of the invention. Following entry of the select information, the present invention returns to the planner information screen 12 and then proceeds forward to an event planner template as at 14. The present invention queries the event planner about whether she has an existing template with the invention, as at 14. For a stored template, the present invention calls up that event template and proceeds to the event phase 20. For a new event template, the invention provides a screen prompting the event planner to create a template as at 15 using select fields about an event and also other templates for regularly utilized screens and printed output, as later described. The fields include the date and time of the event, the location, the name of the venue, the name of the room within the venue, any room requirements such as chairs, tables, linens, and the like. Following development of the fields into a template, the present invention returns to the template screen 14 and then proceeds forward to the event phase 20.

Whether or not a user is an event planner, the present invention begins its event phase 20 by querying the user about entry of event information as at 21. A user who has an event with entered information about that event then proceeds to selection of personalized services as at 30. A user who has not entered information about an event then has the present invention direct her to enter the information about an event as at 22. The present invention requests the event name from the user and upon entry of the event name, the invention calls up the previously developed template. Using the template, the present invention requests event information from the user as at 22. Upon completing the entry of the information about the event into the template, the present invention returns to the event information entry screen 21. With an event created, the invention can create reports, as at 23, related to the event and the planner's management of one or more events, before, during, and after an event, as later shown and described. Following event creation and separate from report generation, the invention proceeds next to personalized services selection phase 30.

The personalized services selection phase begins by as the present invention queries a user about whether such services are desired as at 31. A user who does not want such services then proceeds to the pre-event management phase 40. A user who desires personalized services then proceeds to select them as at 32. As later shown and described, the personalized services include invitation list and production, reservation tracking, memory book production, acknowledgement creation and production, and the like. After the user selects the personalized services, the present invention then turns to the pre-event management phase 40.

The pre-event management phase 40 begins with determining the type of event by the user. This determination opens by presenting a menu of typical events including a funeral 41, a wedding 42, and other event 43. Upon a user selecting a funeral, the present invention moves to operating an event on the day of the event as at 3. For a happier occasion, upon a user selecting a wedding, the present invention then provides a user the ability to create sub-events as at 44. The sub events include bridal shower, couple shower, bachelor party, bachelorette party, wedding ceremony, reception, and the like. A user selects one or all of these events as desired. The user may create a QR code for each event and sub-event. With sub-events identified, the present invention prompts a user to enter invitee information as at 45. Using another template, the present invention presents a screen to the user requesting the name, mailing address, email address, E-Vite® screen name, Facebook® name, personal QR code, and related contact information for each invitee to a sub-event. In cooperation with an event planner, a user then designates sub-events for each invitee using an identifying code for each sub-event as at 46. The code can be an abbreviation of the event title or other identifying alphanumeric combination.

In an alternate embodiment, as wedding planning typically goes, a user or event planner enters the invitees to a first sub-event. The user can then copy that invitee information to additional sub-events and feeds the name and contact information to later events, keeping re-entry of data to a minimum. For people likely to attend just one sub-event, the user can manually enter the invitee information into the database for just that sub-event.

With the invitees each identified to a sub-event by code, the user then generates a mailing list, mailing labels, an email address list, as at 47, or a QR Code for those select invitees for each sub-event. The mailing list then goes upon the outer envelope of an invitation by a printer or a mailing house at user direction for prompt mailing. Alternatively, the collection of mailing labels becomes affixed to the invitations at user direction for mailing shortly thereafter. In a further alternate modern embodiment, the present invention provides an email list of invitees to a sub-event. A user can then compose an email, including a QR code for a sub-event or event, and send it to the email list of invitees. The further alternate embodiment includes composing an invitation for distribution upon Facebook®, E-Vite®, and other social media utilized to connect people.

Then time passes following distribution of the invitations to the sub-events. Then responses to the invitations return. The present invention includes a field for each invitee and each sub-event as at 48. Upon receipt of a response, the user logs acceptance or decline of an invitation in the RSVP field. From time to time, a user or an event planner may want to know the head count or fill rate for a sub-event. To answer that, the user queries the present invention for a report listing those who have accepted and those who have declined an invitation by sub-event. The present invention then sorts the invitee list by sub-event and RSVP field. In time, the response period for an invitation closes and the event approaches its start.

With the RSVPs in, an event planner or user then operates their event as at 3 and the drawings transition to FIG. 1A. To prepare for the invitees, the present invention prepares to collect visitor information as at 50. The present invention queries a user if the event needs a duplicate guest registry as at 51. For larger visitations, funerals, and other events, the event may have multiple computers or terminals for use of guests or the guests may utilize their own smart phones. If the user replies that no duplicate registry is needed, the present invention launches a guest registry at 52. The guest views a guest registry designed by the event planner including registries that follow various themes, primarily towards the registry appearance. The themes include the decedent's name, for example, and various panels on the screen separated by dividers of various line widths and colors. On the other hand, if a user replies that the event does need a duplicate guest registry, the present invention launches the duplicate guest registry at 53. Each of the multiple terminals then includes a guest registry screen that collects information from guest or visitors following the registry theme and delivers that information to a central registry. With the guest registry alone operating or the guest registry and its duplicate in operation, the present invention proceeds to site deployment of the registry as at 4. For the guest registry and the duplicate guest registry, if needed, the registry may operate online, as at 52a, offline, as at 52b, or virtual 52c. When operated online, the registry appears to guests upon a monitor as a webpage maintained from a central remote location. The event planner logs into the central remote location, as later described, and starts the registry and guests then enter information as later described. When operated offline, the registry appears to guests upon a laptop screen or monitor connected to a computer at the event site and without an internet connection. For offline deployment, an event planner downloads and installs the software of the present invention into a laptop computer. The event planner logs into the software, either with temporary internet access to the central remote location or with a code provided by the central remote location previously. The event planner then selects the event, here a funeral, of interest and downloads a pre-populated registry into the laptop. The event planner then takes the laptop to the event site, opens the downloaded registry, and runs the registry for the guests to use. When operated in a virtual mode, the central remote location of the software has created a registry for a funeral. The event planner than requests a uniform resource locator code, or URL, specific to the funeral. The event planner, or an agent such as a webmaster, then places the URL upon the event planner's website or adds HTML code referring to the URL into the event planner's website.

At the site of the event, the present invention operates in a computer readable medium that contains the program code that allows visitors to an event to provide their names, demographic information, and well wishes as at 54. The present invention operates upon a laptop computer, or alternatively a tablet PC or a Smartphone. Upon the computer, the present invention provides a series of screens, as later shown, to the visitor for entry of name, mailing address, email address into the database of the present invention. Visitors may also enter comments into the registry, such as condolences at a funeral, well wishes at a wedding, and observations from a tradeshow. Visitors may enter their information throughout the event and following the event at the discretion of the user and event planner. Further, the invention provides a planner with a QR code. The planner then places the QR code conveniently near the receiving line at an event. A visitor can then use a Smartphone to scan the QR code and have the Smartphone submit information into the invention or bring up screens of the invention upon the Smartphone for information entry by tapping. The QR code guides visitors directly to the remotely located present invention and to the specific event they attend.

After an event, an event planner or user then utilizes the present invention to prepare the visitor information for further usage as at 60. The present invention then queries the event planner as to whether an event utilized a duplicate guest registry as at 61. Where an event had a duplicate registry, the present invention merges the collected visitor information into the guest registry as at 62. Where an event had a guest registry without a duplicate, the present invention proceeds to a query to the event planner regarding an online registry as at 63. As mentioned above, select planners, such as funeral homes, include a virtual guest registry upon the world wide web of the Internet. A virtual guest registry allows people to leave comments and well wishes to the family of the decedent. The people may or may not attend the visitation or funeral for various reasons including lengthy travel. If the event did not have an online registry, the present invention the proceeds to the output phase at 70. If the event had an online registry, the present invention merges the visitor information collected online with the visitor information collected at the event site as at 64.

In the prior art, virtual, or online registries, collect comments until deactivated after a funeral. For a few months after a funeral, the virtual registry remains open for additional comments. After that time period, the virtual registry closes for additional comments. Then the prior art virtual registry remains accessible in a truncated form upon the world wide web. The truncated registry provides an opportunity to reopen the virtual registry for a short time period for a fee. Eventually, the host of the prior art virtual registry will permanently deactivate the registry. With people adding comments to a virtual registry at various times, any print of the prior art virtual registry may lack later comments. Faced with this issue, event planners and decedent relatives may delay printing comments from a virtual registry. In doing so, delayed printing may become never printing. Decedent relatives may overlook printing comments from a virtual registry as they continue with their lives.

The present invention though seeks to overcome the risk of not printing virtual registry comments. The present invention merges comments and information from a virtual guest registry with the guest registries 52 from the event site. During merging of the visitor information, the present invention rectifies the information so the resulting database includes visitor information in the same order though it comes from a guest registry, duplicate guest registry, or online registry.

Following merging of visitor information, the present information proceeds to production of follow on communications as at 70. The follow on communications from the user came from their selection previously as at 32. The follow on communications merge the visitor information into the templates for the communications as at 71. The merge locates name and destination information of a visitor into appropriate locations in the communication along with select comments and photos as later shown. Following the merge, the present invention produces the follow on communications individually addressed to each visitor. The follow on communications can be printed as at 72, such as thank you notes, memos, letters, and books or alternatively can be emailed. Various mailable communications may also have their postage applied as a component of the mail merge. With the follow on communications completed, the user ends the program as at 5.

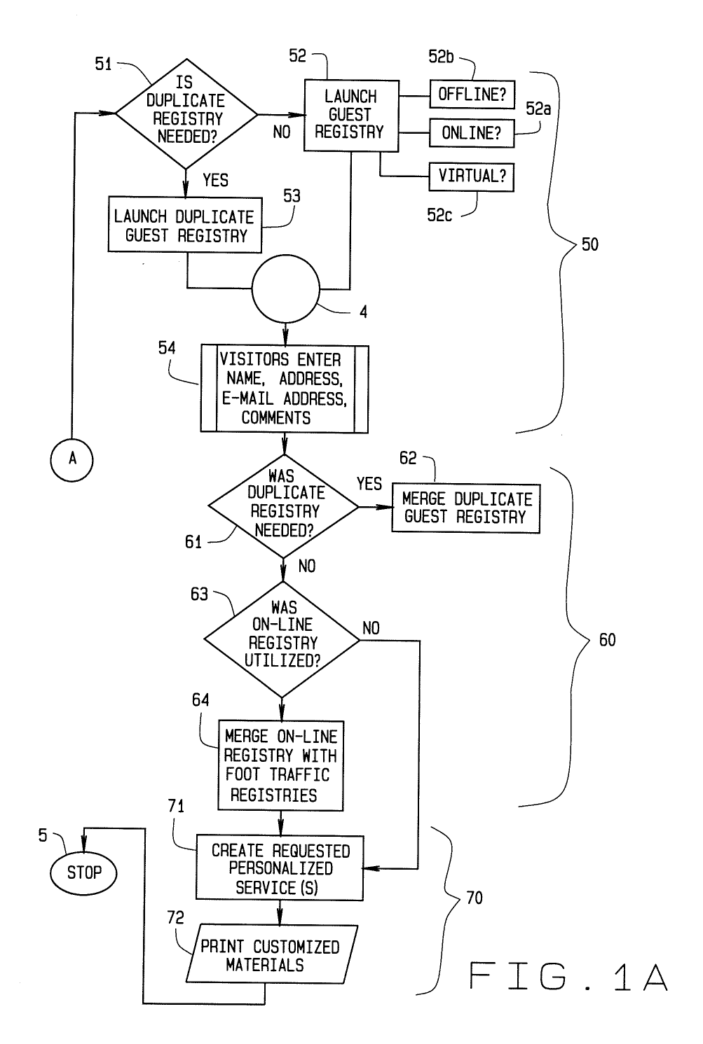

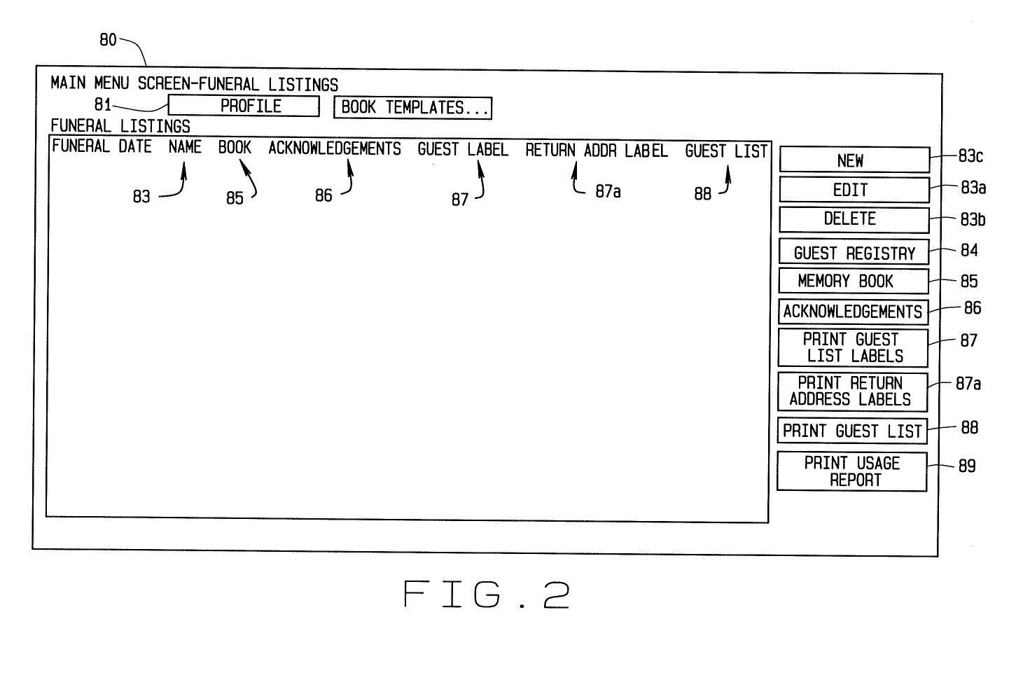

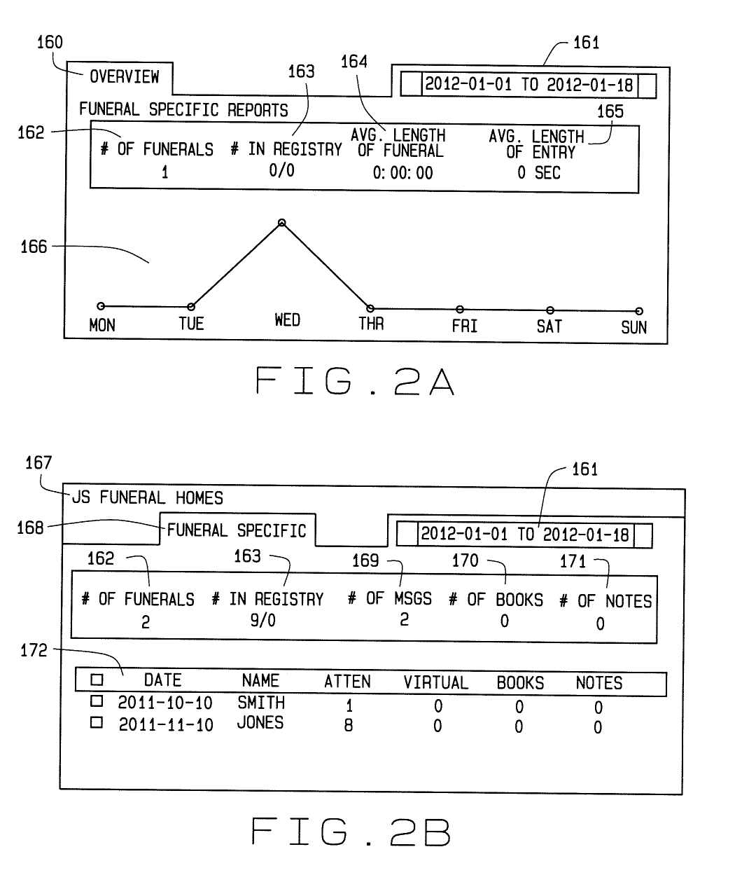

Having described the flow of the invention, FIG. 2 shows the main screen for the present invention, or its dashboard. A user, primarily an event planner, sees this screen following passing a security test, presently successful entry of a username and a corresponding password. This security test restricts usage of the invention to approved users and not the general public. From time to time, the central remote location of the invention will require users to institute a new password or alternatively issue a new password to users. The following description refers to funerals, however the Applicants foresee adaptation of the present invention for weddings and other events. The present invention allows for interactive dynamic rendering of PDF files for its screen entry by visitors and for its follow on communications. The dynamic rendering allows visitors to enter information and the screens and ultimately the follow on communications to expand to fit the information. The dynamic rendering also allows for document creation and editing upon a client side computer. FIG. 2 provides a main menu screen 80 generally viewable to an event planner but not a visitor or guest to an event. The main menu screen allows an event planner, here a funeral director, to view the status of multiple events taking place, often at a single location, usually in time and then date order. The status may also appear as highlighting upon a monthly calendar, either in a single month display or a multi-month display such as two months or three months. The main menu screen serves as the primary navigation reference for the present invention. The main menu screen allows an event organizer to edit a funeral home location or profile 81, create a memory book template 82, input a new funeral 83c, edit an existing funeral 83a, delete a funeral 83b, view a guest registry 84 either entirely or by single entry, create a memory book 85 for a funeral, produce acknowledgments 86, print guest mailing labels 87, print return address mailing labels 87a, print a guest list 88, and generate various reports 89. For each event, i.e. funeral, listed on the main screen, the event planner views the event date, name of the decedent of a funeral as at 83, whether a book is desired at 85, whether acknowledgements have been prepared 86, whether guest mailing labels have been prepared 87, whether return address labels for the event organizer either the funeral director or a person designated by relatives of the decedent have been prepared 87a, and whether a guest list has been printed 88 or alternatively emailed.

Upon viewing the status of events, an event planner may select alternate views as in FIGS. 2a, 2b. FIG. 2a shows a screen with an overview 160 of funerals at a location in a week or other time interval 161. This screen includes statistics such as number of funerals 162, number of funerals in a registry 163, an average of the length of time of a funeral 164, and average length of time to enter information regarding a funeral 165. The screen includes a graphical display 166 that shows the number of funerals associated with a particular date typically shown within a calendar week. The Applicants foresee that the display may show a rolling week, so that funerals before or after a certain date are shown as requested by the event planner. FIG. 2b describes a screen with funerals for a specific, as at 168, named location as at 167. The screen follows a time interval 161 as above that yields the number of funerals 162, the number of funerals in a registry 163, a count of messages as at 169 left by visitors or guests at a funeral, a count of books as at 170 created for funerals, and a count of notes as at 171 created for funerals. Beneath the counts, the screen has a listing 172 of funerals by name and their associated attendance of visitors or guests, books, and notes created.

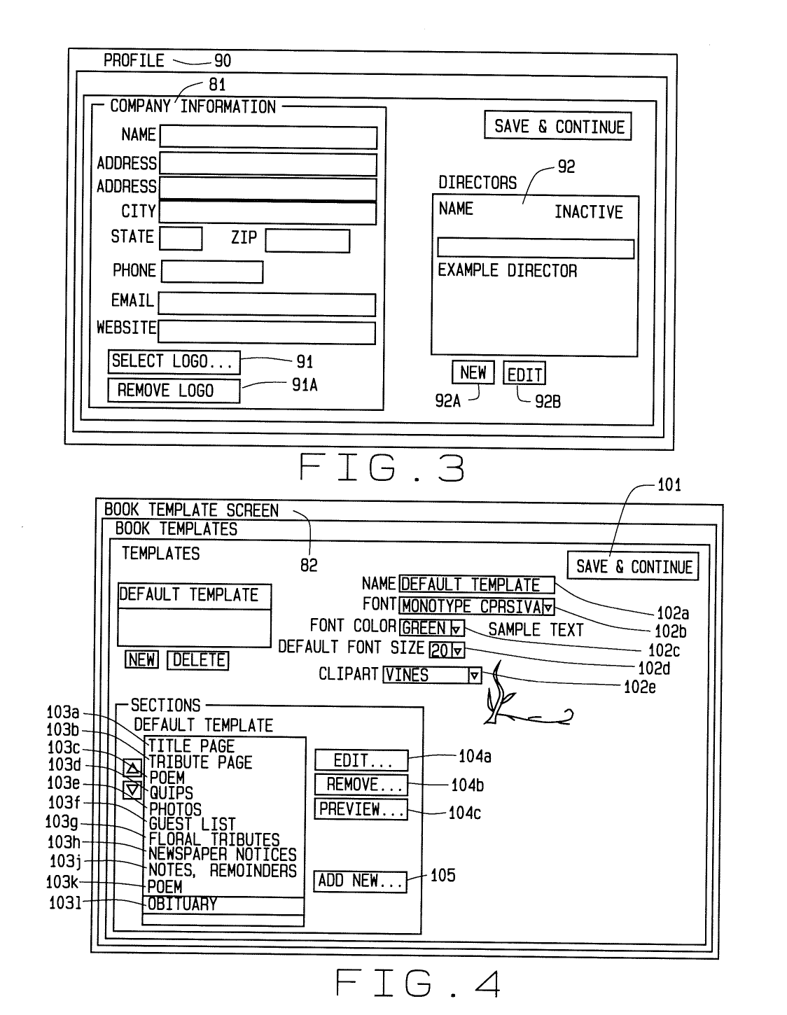

Then FIG. 3 expands on the main menu screen from FIG. 2 by showing a screen, or profile 90, listing the funeral home's 0 information or company information 81. The profile screen collects application information about the funeral home, such as through a second template, such as business name, street address, business telephone number, business email address, business website, Facebook® profile page, and Twitter® handle. The present invention allows usage of a touch pad, tab key, or mouse to navigate the screen and to enter information using a keyboard, mouse, quick, response code reader, bar code reader, light pen, smart pen, microphone, and like peripheral accessories. The screen also provides for inclusion of a logo as at 91 or removal of a logo as at 91a. The logo allows a user to browse various photos provided by the invention or alternatively uploaded by the user to the invention. The logo, in picture form, can then go into a memory book created later. Presently, logos and photos should have JPEG format, however the Applicants foresee adaptation of the invention for future graphic formats. The invention also allows for association of funeral home directors by name to the funeral home as at 92. Once multiple directors associate to the company or funeral home, the present invention allows an event organizer to designate one or more directors as responsible for a particular funeral. Each director is added to the home screen information through the new button 92a and any directory can have his information revised through the edit button 92b.

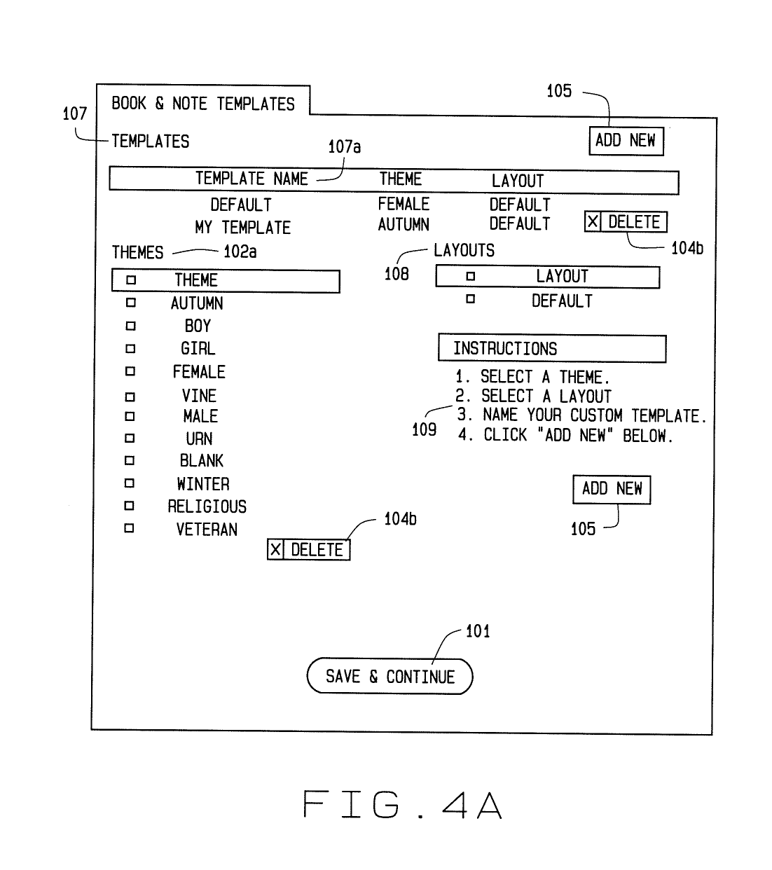

After establishing a funeral home or other event venue with the present invention, a user can then establish a book template 82, or third template, as in FIG. 4. The book template screen as at 82 allows a funeral home to design its memory book template that fits within the customs of its location. Further, the book template allows the funeral home, and select users, to establish format of a book such as typeface, font size, artistic elements, themes, page layouts, and the like. The template utilizes interactive dynamic rendering that allows for creation and editing of the template as the user and the visitors provided information. The dynamic rendering allows for adjusting pagination, insertion of objects, and other editing tasks upon the memory book in real time. The present invention provides a default template 100 that presents all of the features possible for a book utilizing the present invention. The template screen allows a user to select from fonts or typefaces as at 102b, select a font size as at 102d, indicate specific clip art as at 102e, designate pages for regular inclusion in memory books from this funeral home as at 103, and to allow for addition of other pages into memory books. The present invention in this screen 82 lists the templates available beginning with the default template 100. A user can create and name additional templates through clicking upon the new button as at 100a and can remove a template through the delete button as at 100b. When a user completes activity on this screen, the user clicks the save close button as at 101. This screen provides much activity for the user though. The screen allows a user to select and display the name of a template, or theme, as at 102a. In a theme, the user then selects the font as at 102b, typically from a drop down menu listing a plurality of fonts, preferably from Aphrodite pro, Baskerville, museo, Brandon grotesque, century gothic, Georgia, and monotype corsiva, and alternatively arial, and times new roman fonts. The user also identifies a font color as at 102c generally provided in a contrast to the off white, cream, or parchment color paper of the finished memory book. The font color appears in a drop down menu that shows various color swatches as tiny thumbnails. The user also selects a font size as at 102d if different from the default setting of 20 points. And the user also may select from a library of clip art as at 102e displayed as a drown menu. The clip art includes flower, flag, dove, leaves, boat, flower, stars, oak, vine, urn, stripes, and the like. The clip art generally appears in opposing corners of the registry home screen so that the decedent's picture 112 appears between the art. The preceding selections set the appearance of text in the memory book

A memory book produced by a funeral home from a template includes various pages 103 as listed, or components of a book, 200. The template allows a user to select the pages that the present invention later assembles into a book after compilation of guest registry information. The pages include a title page 103a, a tribute page 103b, a first poem as at 103c, quips as at 103d, select photos as at 103e, access to a guest list as at 103f, a list of floral tributes as at 103g, a place for newspaper notices as at 103h, a section for notes and reminders as at 103j, a second poem section as at 103k, and a section for an obituary 103L. Using the arrow keys to the left, a user then selects one or more pages for inclusion into a book. The user may edit an individual page by selecting that page and then clicking the edit button as at 104a. If the user no longer likes a page, the user may remove it by selecting that page and clicking the remove button as at 104b. A user may review and read a page by selecting that page and then clicking the review button 104c. Creative users may also add additional pages into a template by clicking the add new button as at 105.

Having described usage and operation of one book template, the present invention allows for creating multiple templates for Memory Books 200 and Acknowledgements 300, or Notes, as shown in FIG. 4a. This screen has templates 107 listed by an assigned name 107a. Each template includes a theme 102a and a layout 108. The template establishes the basic arrangement and artistic pattern of a book or a note. A user then selects a theme 102a such as autumn, boy, girl, female, vine, male, urn, blank, winter, religious, veteran, mason, fraternal, and the like. The user clicks upon the check box of the desired theme. Upon doing so, the theme associates various preloaded art into the Memory Book design and the Acknowledgement design. The user then selects a layout 108, here showing one default layout. The layout regulates the position of text, art, and photos upon the pages of the Memory Book or the front of the Acknowledgement. As a reminder, this screen includes a checklist 109 to prompt the user about creating a template. A user then saves a template by clicking one of the NEW buttons 105 towards the upper right or towards the right center. Doing so will open a window for the user to enter a name for the template. If a user changes his mind about a theme or an entire template, the user may remove either by clicking one of the delete buttons 104b as shown. Once the user has completed template creation, the user exits this screen by pressing the save and continue button 101 which returns the user back to the screen of FIG. 2.

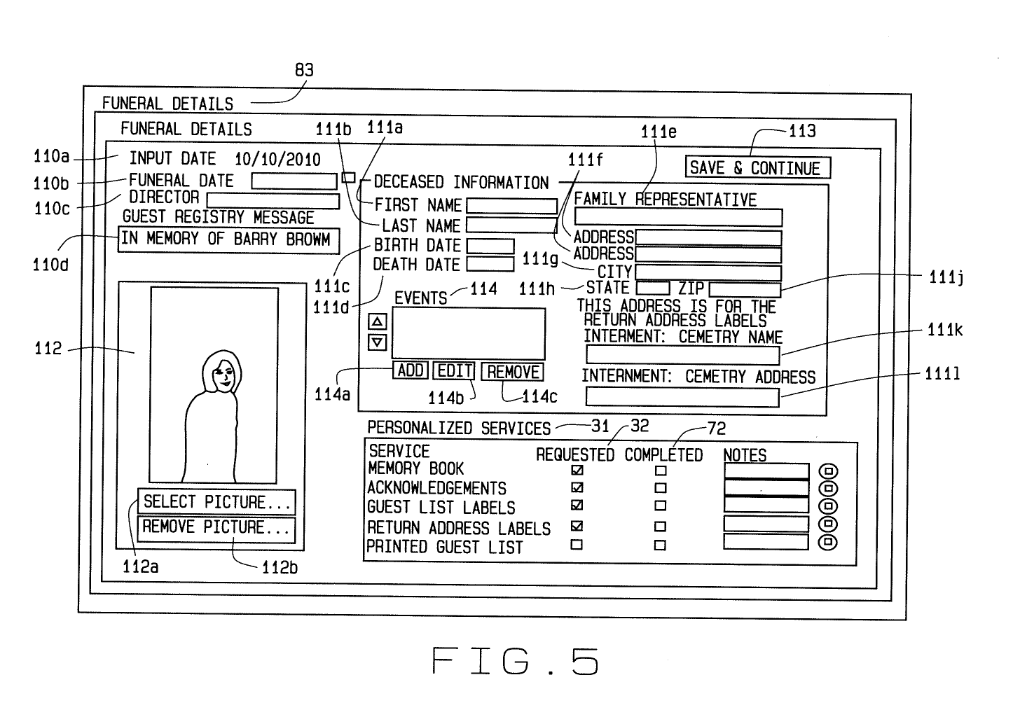

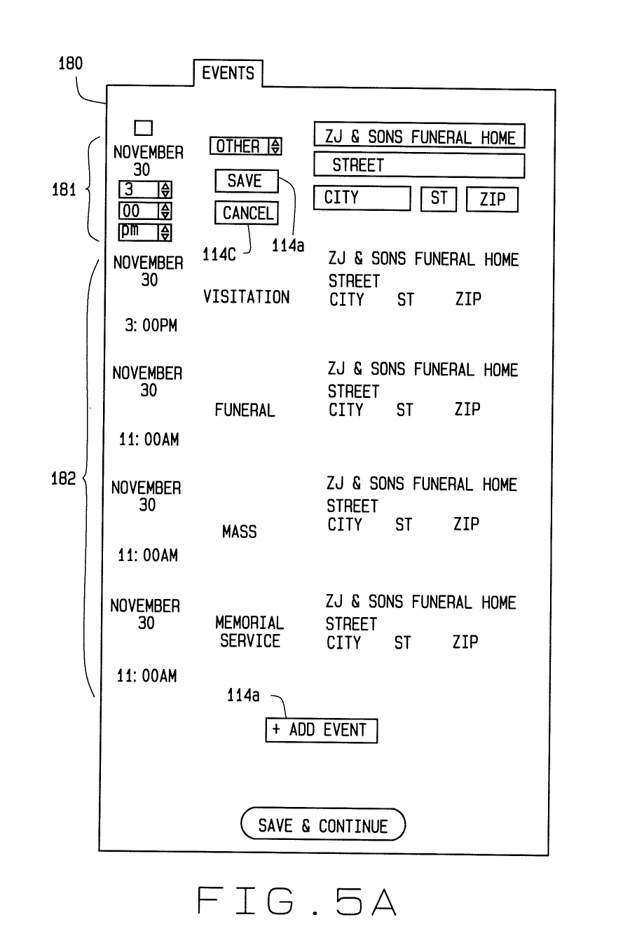

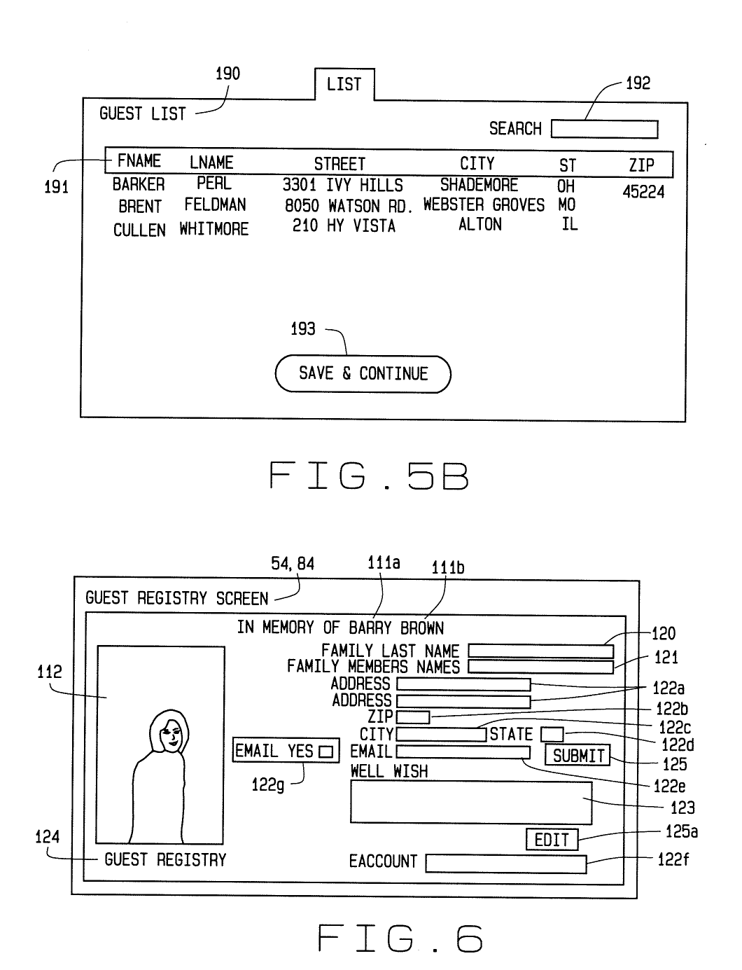

With a book designed, the user then transitions to establishing a record for a specific funeral. FIG. 5 illustrates how a funeral director or other user establishes a record for a funeral. From the main menu 80 in FIG. 2, the user clicked the new button 83 to open the screen for the present invention to receive information, or details, about a funeral as at FIG. 5. This screen shown in FIG. 5 guides a user to enter specific funeral information. The funeral information includes funeral date, name of the decedent, date of birth and date of death for the decedent, a photo, and the name of a family representative. The photo may later appear in a guest registry or enter into the production of a memory book or acknowledgement. The family representative's name may also appear in the signature section of an acknowledgement once produces. This screen also allows a user to select personalized services that associate sub-events for the funeral such as wakes, visitations, masses, interments, funeral lunches, and the like. Usually, a funeral director consults with a user and then makes the entries on the screen regarding the personalized services provided for a funeral.

The details begin with a date of input 110a stating creation of this record. The present invention generally provides this date from the date of the host computer. The user then enters a date of a funeral as at 110b and the name of the funeral director as at 110c. The user may type in the funeral director's name or select a name from a box of names. The user also enters a message, as at 110d, that appears on the opening page and the top of each additional page of an electronic guest registry 52, 53. In consultation with family, the funeral director or other user then enters information as at 111 about the decedent or deceased. This decedent information includes a window for last name as at 111a, a first name window as at 111b, a window for birth date of the decedent as at 111c, and a window for decedent's date of death as at 111d. Related to the decedent, the information includes a window for the name of a family representative as at 111e, the representative's street address as at 111f, city as at 111g, state as at 111h, zip code as at 111j, and alternatively an email address, Facebook® profile name, or Twitter® name. The representative's name and address also feed into creation of return address labels, 47b, and other printed products. Along with decedent and representative information, the details include the name of the interment cemetery as at 111k and its address as at 111L. The information window 111 also includes a box for a brief listing of events as at 114. A user may type times and titles for events in this box. The user adds an event through the add button 114a, then edits an event through the edit button 114b, and may delete an event from the box through the remove button 114c. The funeral details screen also has a portion for selection and display of a photograph of the decedent as at 112. Presently, the photograph must be in an acceptable format, such as JPEG, JPG, PCX, and PDF. The Applicants foresee acceptance of additional file formats once developed. Once a user decides to associate a photograph with the funeral details, the user clicks the select picture button 112a. On the other hand, a user may remove a photograph by clicking the remove picture button 112b.

As an event planner, or user, enters events, as at 114, FIG. 5a shows another embodiment of the event entry screen as at 180, a section for entering a new event as at 181, and a running calendar of the events as at 182 for a specific funeral. The running calendar has for each event the type, date, time, and location as shown. The new event section includes an add button 114a here shown as Save Event and a remove button 114c here shown as Cancel. Beneath the running calendar, this screen 180 includes a second add button 114a in case a user seeks to add an event following review of the running calendar.

After entering the various details related to a funeral or other event, the present invention also presents a list of personalized services selected as at 31. Each service has a block denoting its request as at 32 and then its completion as at 72. Each service also has a line for notes. The services include production of printed materials such as a memory book 72a, acknowledgments 72b such as thank you notes or letters, guest list or invitee labels 47a, return address labels 47b typically for the address of the family representative, and a printed guest list 47c.

Upon selection the service of a guest list as at 47c, the invention opens a guest list screen 190 to the user as shown in FIG. 5b. The guest list screen allows a user to input the first name, last name, address, city, state, and zip code, as at 191, for guests to appear upon a guest list. As a guest list may become extensive, this screen includes a search box 192 that allows a user to seek a specific entry listed in any of the first name, last name, address, city, state, and zip code fields of the list. This screen, as in the other screens, also includes a Save & Continue button 193 that loads entered information into the invention and then takes the user back to the main screen of FIG. 2 or the dashboard of the invention.

Previously, FIG. 5a identified entry of events into a running calendar. However, a user who repeatedly enters events may seek to economize on the entry. FIG. 5c shows a screen 200 that lists various common events 201 associated with a funeral. Each event has a check box as at 202 that receives a keystroke or mouse click. Upon filling a check box, the invention loads associated event information, such as location name and address into the running calendar 182 through the save event button 114a or alternatively into the funeral details screen 83 and particularly the events window as at 114. Using this screen, the user may call up various templates 24 for capturing event information, as shown at 182. The templates may include repeated information as a funeral home name and location.

Time and tide wait for no man, so eventually an event occurs, such as the funeral discussed previously. At the funeral and other related events, the funeral director locates the present invention upon a computer with a display, keyboard, and mouse at table top level upon furniture. Unlike a prior art registry book, incorporating visitor photos, videos, and audio clips at an event site in a compact form requires a computer. The present invention operates upon a computer and collects more information than a prior art registry book. The funeral director, or other planner, may also locate a QR code upon a table top near where visitors enter the wake area or present a QR code upon a monitor for capture by a guest's Smartphone. The visitors can then activate the entry portion of the invention by scanning the QR code upon their Smartphones. Capture of the QR code then takes a guest directly to the registry screen for a particular funeral. The present invention also receives information from the Smartphone via the QR code when enabled, such as name, address, and email address of a guest. FIG. 6 shows a guest registry screen as seen by a person attending a funeral or a related event. When viewing the screen, guests may enter their names, mailing addresses, email addresses, and a well wish to the family of the decedent. The screen ties into select databases so that upon a guest entering a zip code, the present invention populates the state and city name into the mailing address of a guest. After a guest enters her information, the guest saves it into the present invention which clears the screen for usage by the next guest. The guest registry screen may include the photograph of the decedent provided through the funeral details screen earlier. The guest registry screen operates in a secure mode so that the typical guest may not exit from the guest registry screen and enter the remaining modules of the present invention. To exit the guest registry screen, an approved user, such as a funeral director or his staff, presses a select combination of keys or enters a coded last name. The key combination may include CTRL SHFT DEL though other combinations remain foreseen.

When a guest reaches the step of entering information as at 54, the present invention provides a guest registry screen 84. The screen displays the decedent's first name 111a and his last name 111b as previously selected at the top of the screen. Because people generally read left to right, the guest screen provides the picture 112 of the decedent to the left. The picture calls to mind the guest's impressions of the decedent and his family. Beneath the picture, the screen has Guest Registry, the decedent's name 111a, 11b, or other title in larger font as at 124. Adjacent to the picture, the screen has various windows that receive information from the guests. The windows begin with the family last name as at 120. The window just receives the last name of a guest. If a guest comes with other relatives having different last names, each guest must complete a screen. If a guest has other relatives along, then the guest may enter all of the first names of the other relatives in the family members name window as at 121. A guest separates multiple names using commas. Beneath the names, a guest enters a mailing address beginning with the street as at 122a. For guests without other relatives at the funeral, the guest enters her mailing address. For guests with multiple relatives at the funeral, the guest enters the mailing address of the eldest relative or other agreed to relative. Two street address windows 122a are provided by the present invention. Beneath the street address windows, the present invention has a zip code window 122b. Upon entry of a five digits of a zip code, the present invention calls up the corresponding city and state into the city window 122c and state window 122d respectively. If a guest disagrees with the city provided, the guest may overwrite the city. With the mailing address assembled, the guest registry screen has a window for entry of the guest's email address as at 122e after consenting to email communication as at 122g. This window also allows for entry of a guest's Facebook® profile name or a Twitter® as at 122f. And beneath the mailing address and electronic address, this screen provides a field 123 for receiving well wishes and other comments generally through a keyboard and mouse. In an alternate embodiment, the well wish field 123 includes the capability of importing a well wish, or comment, through the share or tagging functions of Facebook® and like text distribution functions of other social media platforms. The field may display a legend nearby that information provided in the field will remain confidential except for release to the family of the decedent. Once a guest is satisfied with her entered information, the guest clicks a submit button as at 125. Doing so transmits the information from the registry screen into the database of the present invention. Doing so also clears the screen for the next guest to use.

A guest not ready to provide comments in the well wish field 123 may defer doing so. Such a guest merely enters his name and address then clicks the submit button 125. Later, the guest may search for his name in the registry to call up his record to add to and to edit the well wish field. A guest does so by clicking upon an edit button as at 125a that opens the well wish field 123 for additional data entry.

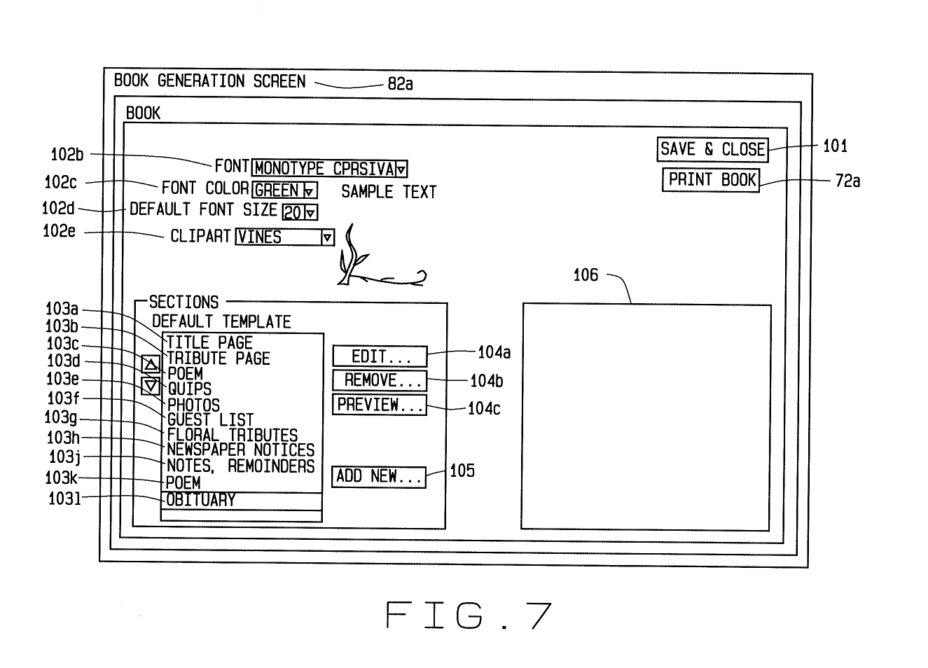

And then the funeral or other event comes to a close. With the guests to the funeral dispersing at its conclusion, entries to the guest register cease. Following entry of all of the funeral details and collection of all of the guest information through the registry, the present invention allows a user to print a Memory Book, as at 72a, as shown in FIG. 7, either in paper form or subject to dynamic rendering of the book in PDF format. The Memory Book memorializes the visitor well wishes, or comments, and other information collected during the funeral. A user selects production of the Memory Book from the main menu screen 80 in FIG. 2, more particularly as at 85. The present invention then prompts the user to select a book template from two or more templates or the present invention defaults to the sole template available. Users still have the ability to revise the details of a book even though they have selected a template. This screen 82a also allows a user to select additional pages base upon the event such as poems and photos. Further, a user adding a new section then sees specific input screens for the additional sections. The present invention allows a user to preview each page of the Memory Book from this screen or even to print the entire Memory Book.

Upon selecting a template, the user can then view the pages of the Memory Book through the page headings as shown. The pages include the title page 103a, the tribute page 103b, a poem 103c, the second poem or quips as at 103d, selected photos as at 103e, a guest list as at 103f usually confirmed with the registry, the list of floral tributes as at 103g, the newspaper notices as at 103h, another poem section as at 103k, and a section for an obituary 103L. Using the arrow keys to the left proximate the title page 103a, a user then selects one or more pages for review prior to printing of the Memory Book. The page appears in a preview window to the right of the sections listed, as at 106. The preview displays among other things the tribute page 103b listing the events associated with the funeral, the obituary 103l for the decedent, photos 103e of the decedent, and related pages as shown. The user may edit an individual page by selecting that page and then clicking the edit button as at 104a. If the user no longer likes a page, the user may remove it by selecting that page and clicking the remove button as at 104b. A user may review and read a page by selecting that page and then clicking the review button 104c. Creative users may also add additional pages into a template by clicking the add new button as at 105. With a book reviewed, the user then transitions to producing the Memory Book.

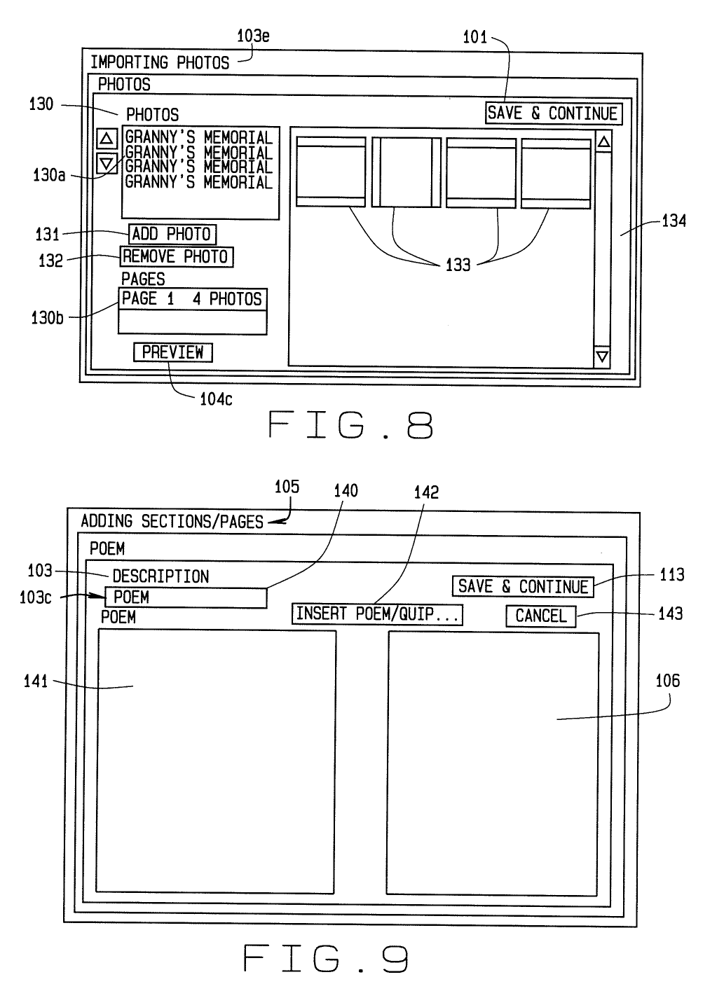

In assembling a Memory Book, the present invention allows a user to import many photos into the book as at 103e. In an alternate embodiment, the photo importation field as at 103e includes the capability of importing a photo or other graphic, through the share or tagging functions of Facebook® and like photo distribution functions of other social media platforms. In a further alternate embodiment, the photo importation field as at 103e includes the capability of importing a video, audio, or other pictorial digital files through file transfer protocols, direct copying from a memory device such as a thumb drive, or through the share or tagging functions of Facebook® and like file distribution functions of other social media platforms. The present invention shows this in FIG. 8 where a user has the flexibility of importing photos of a loved one into the Memory Book. Within the book production screen 82a previously described in FIG. 7, a user adds new photos that the present invention retrieves from a photo source such as a CD, floppy disk, memory stick, jump drive, scanned image, or other electronic photo storage. The user selects suitable photos for the Memory Book, and the present invention merges the photos into the Memory Book. Following selection of the photos, a user may preview each page of photos by selecting a page number. The present invention then brings the photos upon the screen for review.

More particularly, the import photos function 103e opens in a separate screen from that of FIG. 7. The FIG. 8 photo import screen provides a listing 130 of photos 130a uploaded to the present invention to a particular funeral record. The listing begins without any photos and then grows as a user adds photos through clicking the add photo button as at 131. Upon clicking the add photo button 131, the present invention retrieves a photo from storage and displays it on the screen to the right of the list as at 133. The photos may include people, pets, landscapes, buildings, travel shots, and the like accumulated over a lifetime. Upon viewing a suitable photo, the user clicks the add photo button 131 and the title of the photo appears in the listing as at 130a. If a user later decides a photo need not be included, the user clicks upon the remove photo button 132 and the present invention deletes the photo from the Memory Book. The present invention then loads the photos upon a photo page and assigns a photo page number shown as at 130b. A user then views the photos by selecting a page number and then clicking the preview button as at 104c. Where a page has many photos, the present invention includes a scroll bar as at 134 here shown across the top of the preview pane, that is, above photos. The user may arrange the photos on a page in various ways such as one photo above two photos, two photos above two photos, three photos to the left of three photos, two photos above one photo, one photo per page and the like. Once the user is satisfied with the photos selected, the user clicks the save and continue button 101 that then allows the present invention to insert the photos into the Memory Book. The various photos inserted into the Memory Book represent the photos presently seen at funerals often upon an easel. Those photos come together for the funeral but then return to the family members and are often not seen again.

Along with adding photos, a user may add other items to a Memory Book. From the book template screen in FIG. 4, the user presses the add new button 105 and the present invention provides an add page screen 140 as shown in FIG. 9. The add page screen allows a user to select items previously provided by the invention or paste custom items from another source into a Memory Book using the invention. This screen allows for addition of poems, quips, and obituaries as previously described. The add page screen prompts a user to provide text or to choose items created by the invention. Once the user selects an item or provides text into the screen, the user saves the new page and the present invention inserts it into the Memory Book. More particularly, the add page screen provides a window that includes various pages of templates such as the tribute page 103b, the poem as at 103c, the quips as at 103d, the list of floral tributes as at 103g, a place for newspaper notices as at 103h, a section for notes and reminders as at 103j, another poem section 103k, and a section for an obituary 103L. Though this figure shows the poem 103a other pages remain available for selection through a drop down menu. Once the page is selected, the screen opens a text box 141 to receive any text entered by the user. The user can leave various comments or instructions in the text box generally using free form with a keyboard and a mouse. Following entry of desired text, the user clicks an insert button 142 that takes the text and places it into the Memory Book. If the user has a typing mistake or changes her mind, the user may click a cancel button 143 that erases any entries within the text box. A preview of the entered text appears in a window 105. Alternatively, the user may select prewritten poems or quips from a drop down template triggered by hovering a pointer or placing a stylus in the proximity of the page description as at 103. The drop down menu includes for example poems like A Child Loaned, Don't, I'm Free, Let Me Go, Life is but a Stopping Place, and a custom poem, and quips like I Hope the Words, If a Gentle Word, and a custom quip. Upon selecting a custom poem or a custom quip, the user follows the preceding steps about entering custom material in a text box. Once the user has a satisfied entry in the text box and entered it into the Memory Book, the user click the save and continue button 113 and exits the add page screen 140 and returns to the main menu screen as at 80.

With the theme selected, text entered, photos uploaded, and the like as described above, the user may now print, as at 72a, the Memory Book 200 shown in FIG. 9a. Upon receiving a print command, the present invention compiles and assembles the text, photos, and other information in a layout theme. The assembled layout can be printed upon a paper size selected by the user previously in theme setup. The invention defaults to printing the Memory Book 200 upon 8½ by 11 inch paper in a portrait orientation as shown. Alternatively the user may select another paper size from a drop down menu and landscape orientation. The Memory Book includes a cover page 201 that has the decedent's photo 112 centered thereon. Alternatively the cover page includes the decedent's name 111a, 111b proximate the photo. The Memory Book 200 may be bound in various ways including a transparent cover with slip on binder as at 202. The Memory Book 200 now serves its purpose to memorialize and commemorate the memories of those who visited the decedent. The Memory Book will keep those memories for decades hence.

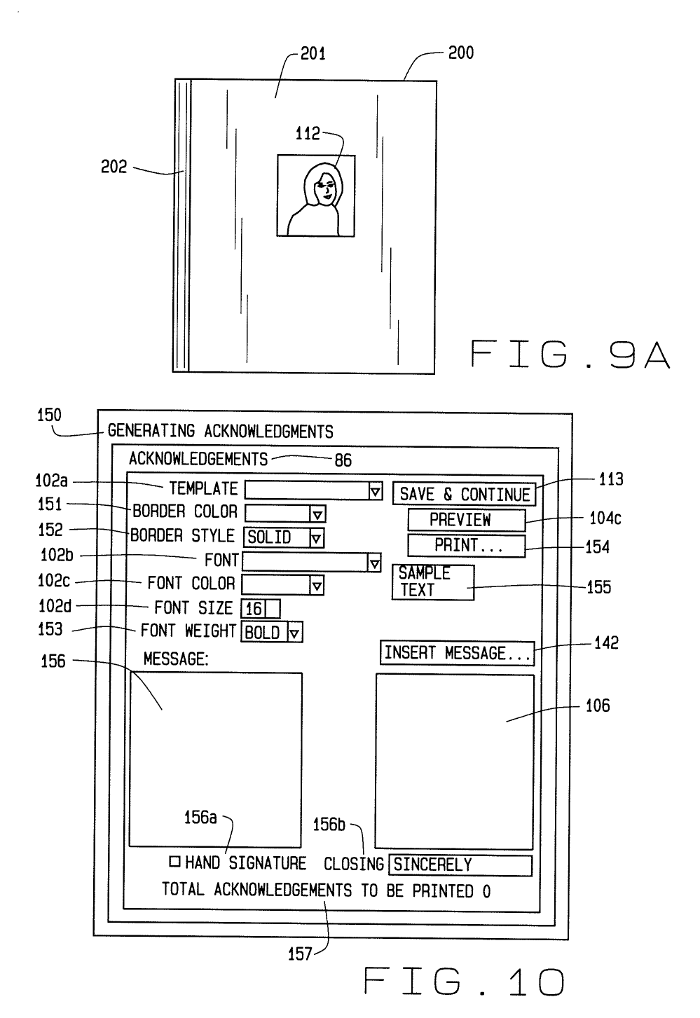

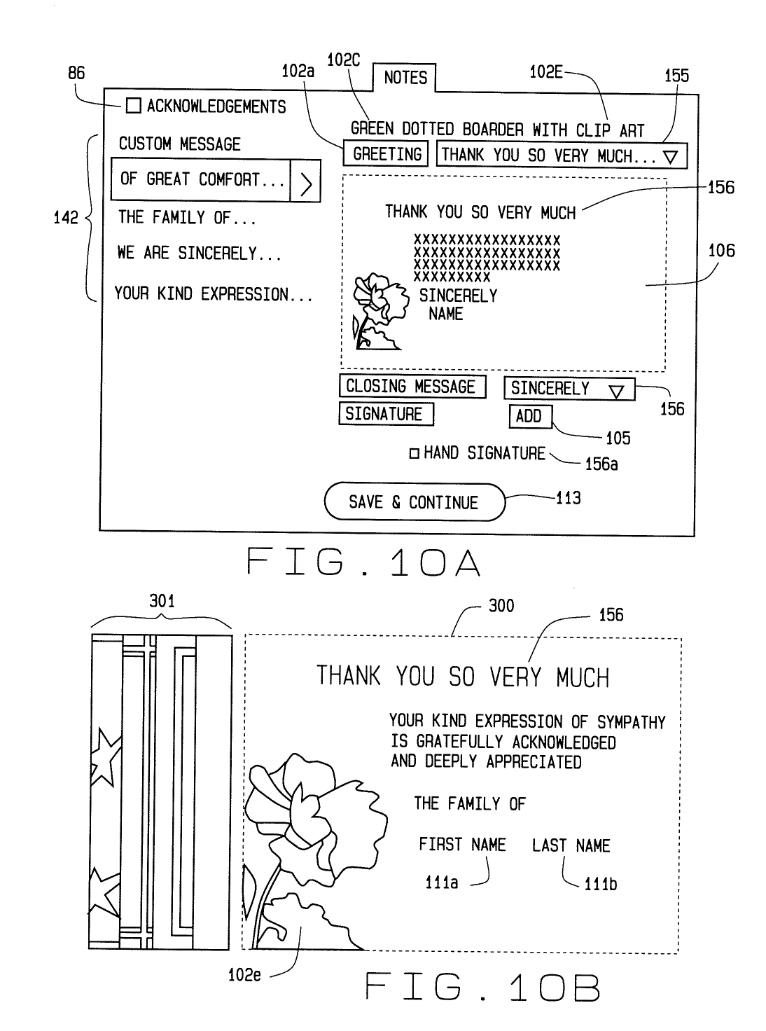

Following an event, a user may desire to communicate thanks or appreciation to the event's guests or visitors. And from the main menu 80, a user selects production of acknowledgements as at 86 where acknowledgement serves as a missive sent from the family of the decedent as a last gesture to a guest. The missive may take various forms such as a letter, a note, a card, a memo, and the like. Upon doing so, the present invention presents an acknowledgement screen 150 shown in FIG. 10. Following creation of a guest list, as at 47 and 88, a user can then prepare and produce custom acknowledgements such as thank you notes. From the main menu 80, the user selects a specific funeral as at 83, and then selects acknowledgments 86. At the screen 150, users view a template similar to the Memory Book clip art screen, see FIG. 7. The screen allows for selection of a theme, and then borders if desired, or no border, if the user provides preprinted paper. Following selection of specific fonts, the user selects a message. A user can then choose from a drop down menu of common messages appropriate to the event, such as a funeral, for example Of Great Comfort, The family of, We are sincerely, Your kind expression, and the like. Then the user saves the common message and the message appears in a text box. The user may then choose whether to use a hand signature or a printed signature on the acknowledgment. Upon selecting a hand signature, the family representative will have her name in the signature line of the acknowledgment. This screen also allows a user to preview an acknowledgment before printing. However, without a guest entry in the guest registry, this screen will not display a preview image.

More particularly, the screen provides a window where a user selects a template as at 102a, or a theme. From there, the user selects a border color for the printed acknowledgement through a drop down menu as at 151. The user also selects the style of the border, such as solid, hollow, outlined, and the like from another drop down menu as at 152. The acknowledgement also includes text where the user selects the font as at 102b, the font color from a drop down menu as at 102c, the font size in points as at 102d, and a font weight such as bold, underlined, italic, and the like from another drop down menu as at 153. While making these selections, this screen provides a small view of the text in window 155, or thumbnail. With the font information selected, the user then types a message into the message box 156. The user may do so using a keyboard and mouse or alternatively may paste in text from another source. Further, the user may select a prewritten message from a drop down menu and insert it into the Memory Book by clicking an insert button 142, for example Of Great Comfort, The family of, We are sincerely, Your kind expression, and the like as later shown in FIG. 10a. With the message selected or compose, the user than indicates whether the acknowledgment will have a handwritten signature or not through a check box 156a. The user next selects the form of the closing from a menu as at 156b. In coordination with the guest registry, this screen identifies the number of acknowledgments for printing as at line 157. With a message composed and an acknowledgment laid out, the user can view an acknowledgment ready for printing by clicking the preview button 104c. Upon doing so, an image of the acknowledgment appears upon the screen for viewing, as in 106. When the acknowledgment satisfies the user, the user may print one, some, or all acknowledgments using the print button 154. When the user must temporarily stop work on the acknowledgments or has completed printing them, then the user clicks the save and continue button 113 so the acknowledgement and message remain within the present invention. An alternate embodiment of the note generation screen appears in FIG. 10a.

And with the theme selected and text entered as just described, the user may now print, as at 86, an Acknowledgement 300 shown in FIG. 10b. Upon receiving a print command, the present invention compiles and assembles the text and other information in a layout theme. The assembled layout can be printed upon a paper size selected by the user previously in theme setup. The invention defaults to printing the Acknowledgement 300 upon 4 by 6 inch card stock in landscape orientation as shown. Alternatively the user may select another card size or fold pattern from a drop down menu. The Acknowledgement includes the message 156 whether custom or pre-written, the decedent's name 111a, 111b, and themed artwork 102e. Alternatively, the Acknowledgement may include the decedent's photo 112 if desired. The Acknowledgement is typically unbound but does include an artistic treatment, shown in a plurality of examples as at 301, of at least the left margin of the card. The Acknowledgement 300 now completes its gracious mission of a last gesture related to the decedent by the family.

From the aforementioned description, a method to register visitors has been described. The registration method is uniquely capable of selecting event related services and products, generating event invitations, tracking RSVP, collecting visitor information, creating printed books from the visitor information, and creating printed addressed acknowledgements for mailing, or alternatively electronic distributions. The method to register visitors and its various components may be written in many programming languages including but not limited to assembly, FORTRAN, BASIC, C, C++, Pascal, Visual Basic, HTML, JAVA, and XML and may be installed upon many computers including but not limited to mainframes, desktops, portable digital assistants, and networks.

We claim:

1. A method for registering a plurality of visitors to an event and providing documents with information from the visitors to a user, comprising the following steps:
listing an event planner;
identifying an event;
selecting personalized services related to the event upon election of said user;
collecting information from the visitors at the event utilizing an electronic registry;
preparing information from the visitors following the event; and,
producing documents including information from the visitors, said documents being suitable for mailing or electronic transmission;
wherein the preceding steps occur upon a computer;
wherein said user provides personalized communications to the visitors following an event and said user receives a document memorializing an event including information from the visitors to the event.

2. The method for registering visitors of claim 1 further comprising:
said identifying an event including a template having at least one window for assembling information regarding an event; and,
said listing an event planner including a second template having at least one window for assembling information regarding a venue hosting the event.

3. The method for registering visitors of claim 1 further comprising:
said selecting personalized services including at least one of establishing an electronic guest registry, establishing a manual guest registry, creating at least one sub-event, issuing invitations to said sub-event, tracking reservations for said sub-event, printing address labels related to invitees to said sub-event, and identifying desired documents for said producing documents.

4. The method for registering visitors of claim 1 further comprising:
said producing documents including a third template having at least one window for designating at least one element of formatting a document and at least one window for selecting at least one component of a document.

5. The method for registering visitors of claim 4 wherein said document includes one of a book, memo, note, letter, card, or text suitable for to electronic transmission.

6. The method for registering visitors of claim 1 further comprising:
said collecting information from the visitors presents a screen to each of the visitors wherein said screen has at least one window for entry of information through at least one of a keyboard, a mouse, a quick response code reader, a bar code reader, a light pen, a smart pen, and a microphone; and,
said collecting information storing information from each of the visitors within a confidential database upon a computer.

7. The method for registering visitors of claim 4 further comprising:
said producing documents merging information from the visitors into said third template.

8. The method for registering visitors of claim 7 wherein said merging information from the visitors into said third template produces at least one book compiling information from the visitors.

9. The method for registering visitors of claim 7 wherein said merging information from the visitors into said third template produces at least one missive from said user to each of the visitors acknowledging attendance at the event, wherein said missive includes one of a memo, a note, a letter, a card, or text suitable for electronic transmission.

10. A method for registering a plurality of visitors to an event and providing documents and information about the visitors to a user, comprising the following steps:
identifying an event and including a template having at least one window for assembling information associated to the event, and a second template having at least one window for assembling information regarding the location of the event;
selecting personalized services related to the event upon election of said user, having at least one of establishing an electronic guest registry, and including at least one of establishing a manual guest registry, creating at least one sub-event, issuing invitations to said sub-event, tracking reservations for said sub-event, printing address labels related to invitees to said sub-event, and identifying desired documents for later production;
collecting information from the visitors at the event utilizing an electronic registry, said collecting information presenting a screen to each of the visitors wherein said screen has at least one window for entry of information through at least one of a keyboard, a mouse, a quick response code reader, a bar code reader, a light pen, a smart pen, and a microphone, said collecting information storing information in a confidential database upon a computer located away from the event;
preparing information from the visitors to the event; and,
producing documents including information from the visitors, and including a third template having at least one window for designating at least one element of formatting a document and at least one window for selecting at least one component of a document, said third template receiving information from the visitors, said documents being suitable for mailing or electronic transmission, said documents including at least one of a book, memo, note, letter, card, or text suitable for electronic transmission;
wherein the preceding steps occur upon a computer;
wherein said user provides personalized communications to the visitors following an event and said user receives a document memorializing an event including information from visitors to the event.

12. The event visitor registration method of claim 11 further comprising:
said third template producing a book compiling information from the visitors and at least one missive from said user to each of the visitors acknowledging attendance at the event, wherein said missive includes one of a letter, a note, a memo, a card, and text suitable for electronic transmission.

13. The event visitor registration method of claim 11 wherein the event is one of a funeral, wedding, religious ceremony, or trade show.

14. A device registering visitors to an event and producing documents including information from the visitors for delivery to a user, comprising:
at least one computer readable medium including stored thereon program code that upon execution thereof, said program code identifies an event, selects at least one personalized service upon election of said user, creates at least one sub-event, issues invitations to said sub-event, and tracks reservations for said sub-event, collects information from the visitors at the event utilizing an electronic registry upon a computer, prepares information from the visitors, and produces documents containing information from the visitors;
wherein said documents are suitable for mailing or electronic transmission;
wherein said user sends at least one personalized communication to the visitors from said producing documents; and,
wherein said documents include at least one book memorializing an event with information from the visitors to the event.
